(19) United States
(12) Patent Application Publication
(10) Pub. No.: US 2015/0134742 A1
(43) Pub. Date: May 14, 2015

(54) TECHNOLOGY OF SUPPORTING MEETING

(71) Applicant: SHARP KABUSHIKI KAISHA, Osaka (JP)

(72) Inventors: Ryuji IKEDA, Osaka (JP); Kazuo MAKIJIMA, Osaka (JP); Yasuaki TACHIIRI, Osaka (JP)

(21) Appl. No.: 14/535,377

(22) Filed: Nov. 7, 2014

(30) Foreign Application Priority Data
Nov. 8, 2013 (JP) 2013-232147

(51) Int. Cl. H04L 29/06

(52) U.S. Cl. CPC H04L 65/403
USPC 709/204

(57) ABSTRACT

A server included in a meeting support system plays back a content correlated with a meeting, and synchronously distributes a playback result to a plurality of terminal devices. The server stores a time the meeting is held, the content played back in the meeting, and a user who participates in the meeting in a memory as a meeting history in each meeting. The server transfers information about the meeting that an assigned user participates in and the content played back in the meeting in order to present the information in the terminal device in accordance with user assignment received from the terminal device. The information is registered in the meeting history.

This nonprovisional application is based on Japanese Patent Application No. 2013-232147 filed on Nov. 8, 2013 with the Japan Patent Office, the entire contents of which are hereby incorporated by reference.

### BACKGROUND OF THE INVENTION

1. Field of the Invention

The present disclosure relates to a technology of supporting a meeting, particularly to a technology of supporting a meeting involving playback of a content with a plurality of terminal devices.

2. Description of the Background Art

Various systems are proposed as a support system to support the meeting in which the plurality of terminal devices connected to a network are used. For example, Japanese Patent Laying-Open Nos. 2008-090383, 2006-148730, 2009-075626, 2009-122839, 2006-005589, 2000-092048, 2000-092217, 2006-005590, and 2007-293454 disclose meeting support systems.

### SUMMARY OF THE INVENTION

When the meeting support system is used, users located away from each other can participate in the meeting so as to sit around an identical meeting material and an identical whiteboard. For this reason, there is a need for the meeting support system to more smoothly support holding and progress of the meeting.

In accordance with one aspect, a meeting support method of supporting a meeting involving playback of a content using a server and a plurality of terminal devices connected to the server is provided. The meeting support method includes: playing back the content correlated with the meeting and synchronously distributing a playback result to the plurality of terminal devices using the server; storing an information identify a time the meeting is held, the content played back in the meeting, and an information identify a user who participates in the meeting, as a meeting history in each meeting; referring to the meeting history to present information about the meeting that an assigned user participates in and the content played back in the meeting, on the terminal device in which the user is assigned; and referring to the meeting history to present information about a user who plays back a selected content in the presented contents, on the terminal device with which the content is selected.

Preferably, the storing includes storing an information identify a user who logs in at a time the meeting is held, in the meeting history as the user who participates in the meeting.

More preferably, the storing includes storing an information identify a playback period of each content and an information identify a login period of the user in the meeting history.

Preferably, the meeting support method further includes registering the content to be played back in the meeting and the user who plans to participate in the meeting as meeting information in each meeting. The distributing includes referring to the meeting information to play back the content using the server. The registering includes receiving a previously-defined manipulation to register the meeting information on a new meeting in which the user who plays back the selected content is the user who plans to participate in the meeting.

In accordance with another aspect, a server that supports a meeting involving playback of a content with a plurality of terminal devices is provided. The server includes: a playback unit for playing back the content; a communication unit for communicating with the plurality of terminal devices; a controller; and a memory. The controller is configured to cause the playback unit to play back the content correlated with the meeting, and synchronously distribute a playback result of the playback unit to the plurality of terminal devices. The memory is configured to store an information identify a time the meeting is held, the content played back in the meeting, and an information identify a user who participates in the meeting are stored as a meeting history. The controller is configured to transfer information about the meeting that an assigned user participates in and the content played back in the meeting in order to present the information on the terminal device in accordance with user assignment received from the terminal device, the information being registered in the meeting history, and transfer information about the user who plays back a selected content in order to present the information on the terminal device in accordance with content selection in the content transferred in accordance with the user assignment received from the terminal device, the content selection being received from the terminal device, the information being registered in the meeting history.

Preferably the user who participates in the meeting registered in the meeting history includes an information identify a user who logs in at a time the meeting is held.

More preferably the meeting history includes an information identify a playback period of each content and an information identify a login period of the user who participates in the meeting.

Preferably the memory is further configured to store the content to be played back in the meeting and an information identify the user who plans to participate in the meeting are stored as meeting information in each meeting. The controller is configured to refer to the meeting information to cause the playback unit to play back the content, and register meeting information on a new meeting, in which the user who plays back the selected content is the user who plans to participate in the meeting, in the storage area in accordance with a previously-defined manipulation.

In accordance with still another aspect, a terminal device that supports a meeting involving playback of a content is provided. The terminal device includes: a communication unit for communicating with a server; an instruction device; a display unit; and a controller. The controller is configured to display a playback result of the content correlated with the meeting on the display unit, the playback result being received from the server. A memory of the server is configured to store an information identify a time the meeting is held, the content played back in the meeting, and an information identify a user who participates in the meeting are stored, as a meeting history in each meeting. The controller is configured to display information about the meeting that an assigned user participates in and the content played back in the meeting on the display unit in accordance with user assignment received from the terminal device, the information being registered in the meeting history, and display information about the user who plays back a selected content on the display unit in accordance with content selection in the content transferred in accordance with the user assignment received from the terminal device, the content selection being received from the terminal device, the information being registered in the meeting history.

In accordance with yet another aspect, a meeting support system that supports a meeting involving playback of a content is provided. The meeting support system includes: a module for playing back the content correlated with the meeting to synchronously distribute a playback result to a plurality of terminal devices using a server; a module for storing an information identify a time the meeting is held, the content played back in the meeting, and an information identify a user who participates in the meeting, as a meeting history in each meeting; a module for referring to the meeting history to present information about the meeting that an assigned user participates in and the content played back in the meeting on the terminal device with which the user is assigned; and a module for referring to the meeting history to present information about a user who plays back a selected content in the presented contents on the terminal device with which the content is selected.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating an example of a configuration of a meeting support system (hereinafter, simply referred to as a system) according to an exemplary embodiment.

FIG. 2 is a block diagram illustrating an example of a hardware configuration of a server included in the system.

FIG. 3 is a block diagram illustrating an example of a hardware configuration of a terminal device included in the system.

FIG. 4 is a view illustrating a display screen of the terminal device.

FIG. 5A to FIG. 6B are views illustrating a function of a button used to issue an instruction to display a pointer on the display screen in FIG. 4.

FIG. 7A is a view illustrating a function of a button used to issue an instruction to input a handwritten image on the display screen in FIG. 4.

FIG. 7B is a view illustrating a function of a button used to issue an instruction to input a marker on the display screen in FIG. 4.

FIG. 8 is a view illustrating an outline of operation of the system during a meeting.

FIG. 9 is a view illustrating an example of a meeting history.

FIG. 10 is a view illustrating an example of input information stored in a memory as meeting information.

FIG. 11 is a view illustrating an example of previously-registered meeting information.

FIG. 12 is a view illustrating an example of a user participation history on a meeting support screen.

FIG. 13 is a view illustrating a presentation example of a user who browses a selected content on the meeting support screen.

FIG. 14 is a view illustrating a display example of a screen used to register meeting information on a new meeting.

FIG. 15 is a view illustrating an outline of the operation of the system during a presentation and a new registration.

FIG. 16 is a block diagram illustrating an example of a functional configuration of the server.

FIG. 17 and FIG. 18 are flowcharts illustrating an example of the operation of the server.

### DESCRIPTION OF THE PREFERRED EMBODIMENTS

Hereinafter, an exemplary embodiment of the present invention will be described with reference to the drawings. In the following description, the identical component and constituent is designated by the identical numeral, and has the identical name and function. Accordingly, the overlapping description is not repeated.

<System Configuration>

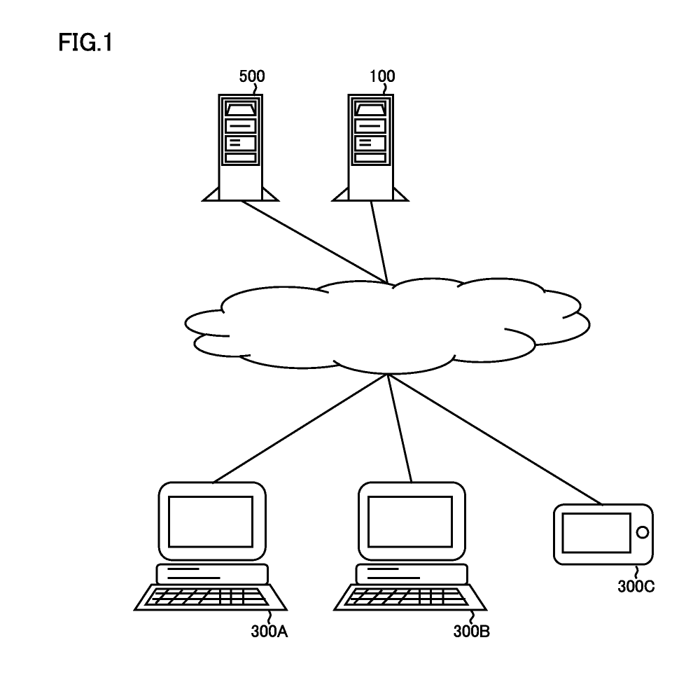

FIG. 1 is a view illustrating a specific example of a configuration of a meeting support system (hereinafter, abbreviated to a system) according to an exemplary embodiment. Referring to FIG. 1, the system includes a meeting support server (hereinafter, abbreviated to a server) 100 and terminal devices 300A, 300B, and 300C that are used by users who participate in a meeting. Terminal devices 300A, 300B, and 300C are collectively called a terminal device 300.

Any device may be used as terminal device 300 as long as the device can receive output of a playback content and a manipulation of a user. For example, terminal device 300 is a PC (Personal Computer) or a mobile terminal. Any device may be used as server 100 as long as the device includes a computer that can perform later-described processing. Server 100 may be a general PC. Alternatively, a function of server 100 may be loaded on at least one of terminal devices 300A, 300B, and 300C.

These devices are connected to a network to be able to communicate with each other. A public line such as the Internet is used as the network. Alternatively, a dedicated line such as a LAN (Local Area Network) may be used as the network.

As illustrated FIG. 1, other devices such as a server 500 may be connected to the network. In the case that server 500 is connected to the network, the system can access server 500 to use a content stored in a memory of server 500.

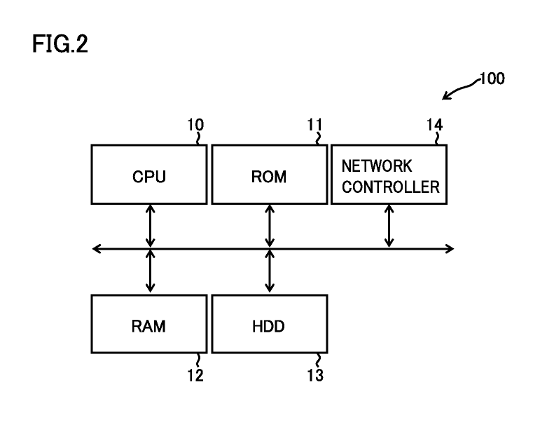

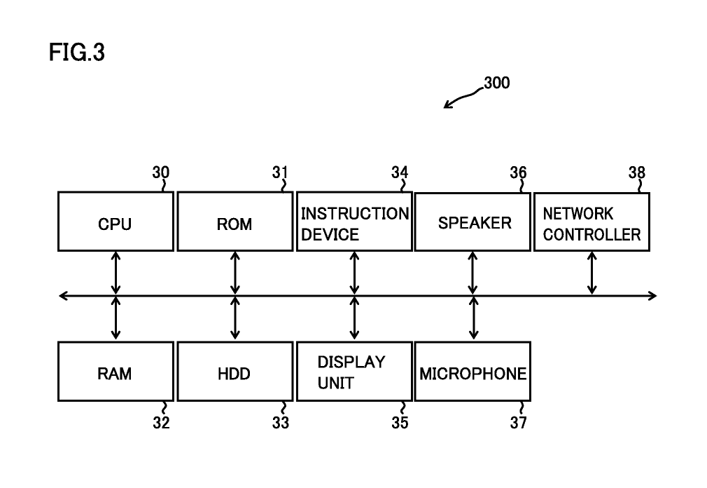

FIG. 2 is a block diagram illustrating an example of a hardware configuration of server 100. FIG. 3 is a block diagram illustrating an example of a hardware configuration of terminal device 300. Both server 100 and terminal device 300 may be a general PC. Therefore, FIG. 2 and FIG. 3 each illustrate an example of the hardware configuration in the case that the general PC is used as server 100 and terminal device 300.

Referring to FIG. 2, server 100 includes a CPU (Central Processing Unit) 10 that controls a whole of the device. Server 100 includes a ROM (Read Only Memory) 11, a RAM (Random Access Memory) 12, and an HDD (Hard Disk Drive) 13. A program executed by CPU 10 and the like are stored in ROM 11. When CPU 10 executes the program, a calculation value is stored in RAM 12 or RAM 12 becomes a work area. HDD 13 is an example of a memory device in which meeting information and a meeting history are stored. Server 100 includes a network controller 14. Network controller 14 controls communication with terminal device 300 through the network.

Referring to FIG. 3, terminal device 300 includes a CPU 30 that controls a whole of the device. Terminal device 300 includes a ROM 31, a RAM 32, and an HDD 33. A program executed by CPU 30 and the like are stored in ROM 31. When CPU 30 executes the program, a calculation value is stored in RAM 32 or RAM 32 becomes a work area. HDD 33 is an example of a memory device in which various pieces of data are stored. Terminal device 300 includes an instruction device 34, a display unit 35, a speaker 36, a microphone 37, and a network controller 38. Instruction device 34 is a device (or a device connected to the device), such as a keyboard and a mouse, which receives an instruction manipulation of the user. Network controller 38 controls communication with server 100 through the network.

### First Embodiment

### Outline

The system used by the plurality of users also supports holding and progress of the meeting even if the plurality of users are in remote places.

Server 100 plays back a registered content at a time previously registered as a time appointment. Server 100 starts distribution of a playback result to a plurality of terminal devices 300 used by a plurality of login users. The meeting may be started by this operation of server 100.

Alternatively, server 100 plays back an assigned content in accordance with an instruction issued from terminal device 300 used by one of the login users or the login user having specific authority. Server 100 starts the distribution of the playback result to a plurality of terminal devices 300 used by the plurality of login users. The meeting may be started by this operation of server 100.

In the case that one of the plurality of terminal devices 300 retains the content, one terminal device 300 plays back the content. One terminal device 300 transfers the playback result to server 100. The playback result may be distributed to other terminal devices 300 through server 100.

At the beginning of the meeting, server 100 may perform authentication processing of the user who participates in the meeting based on login information from each terminal device 300.

For example, the playback of the content includes display of a document file, playback of a moving image, and sound output. Server 100 plays back contents such as the assigned document file by reading the contents from other devices such as HDD 13 and server 500. Server 100 distributes the playback result to terminal devices 300 used by the plurality of login users in a synchronous manner in principle.

Each terminal device 300 outputs the content playback result distributed from server 100 in synchronization with other terminal devices 300. Therefore, using terminal devices 300, the plurality of users who participate in the meeting can obtain the content playback result (for example, the display of the document file) in synchronization with other terminal devices 300 even if the users are in remote places.

Each terminal device 300 receives the instruction manipulation of the user to notify server 100 of information about a manipulation content. For example, the instruction manipulation is a manipulation to perform input of the content or a positional instruction.

The content or instruction position input to terminal device 300 is distributed to other terminal devices 300 by server 100 together with the content playback result. Therefore, each of the plurality of users who participate in the meeting can remotely share the input content or instruction position of other users using terminal device 300.

(Display Screen)

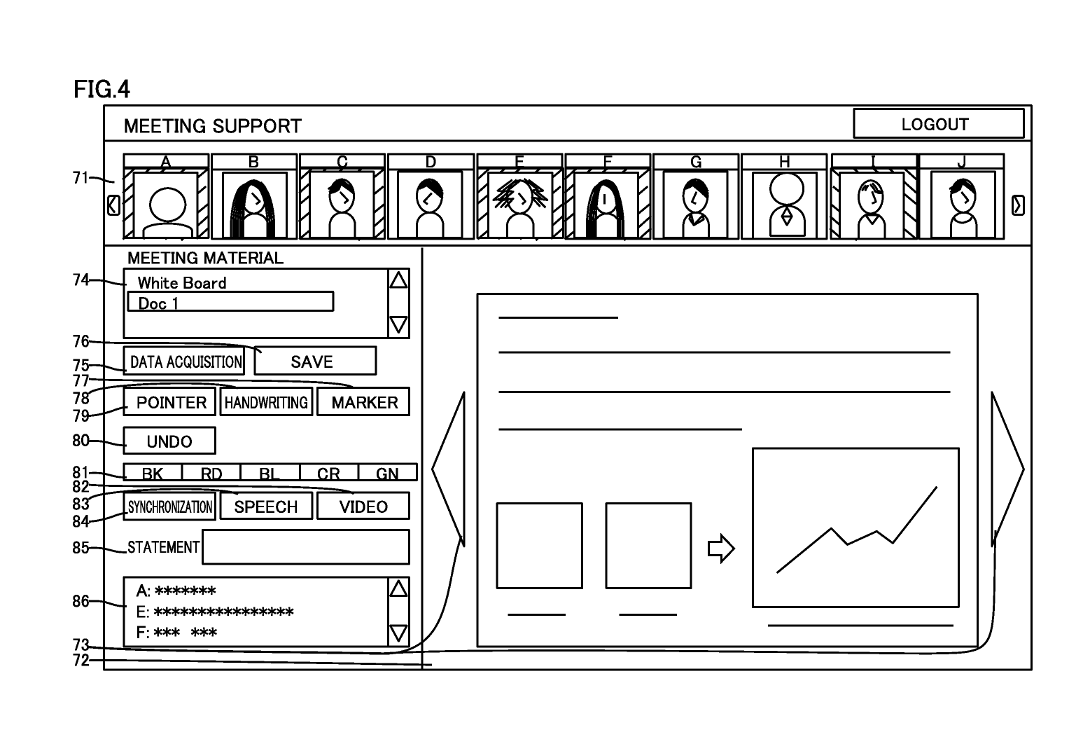

FIG. 4 is a view illustrating a display screen of terminal device 300. FIG. 4 illustrates an example of a meeting support screen. The display screen in FIG. 4 is displayed on display unit 35 of terminal device 300 when the user participates in the meeting using terminal device 300.

Referring to FIG. 4, the meeting support screen includes a display 71 for users who can use the system and a content display (output) 72.

The meeting support screen includes a meeting material display 74, a statement field 85, and a display field 86. The meeting material is a content that is registered as the content to be played back while correlated with the meeting. Statement field 85 receives text input. Display field 86 sequentially displays the text input from the user who participates in the meeting.

The meeting support screen includes buttons 73 and 75 to 84. Button 73 is used to receive an instruction of a content playback (display) position. Button 75 is used to issue an instruction to download, to terminal device 300, content data that is of the meeting material. Button 76 is used to issue an instruction to store the downloaded content data in HDD 33 of terminal device 300. Button 77 is used to issue an instruction to start and stop processing of inputting a marker. Button 78 is used to issue an instruction to start and stop processing of inputting a handwritten image. Button 79 is used to issue an instruction to identify the user to display a pointer. Button 80 is an undo button. Button group 81 is used to select colors of the handwritten image and marker. Button 82 is used to issue an instruction to start and stop a video meeting. Button 83 is used to issue an instruction to start and stop speech. Button 84 is used to issue an instruction of synchronous/asynchronous output of the content playback result.

When receiving the content playback result from server 100, terminal device 300 displays the content playback result on the meeting support screen. Server 100 transmits identification information on playing-back content to terminal device 300 together with the content playback result. Therefore, in the meeting materials that are registered while correlated with the meeting, the currently playing-back meeting material is presented in display 74 on the meeting support screen.

(User Display)

Display 71 displays the user who can use the system by, for example, an icon. Display 71 may display the user who can use the system by a text such as a name. Preferably display 71 distinguishes the user who participates in the currently holding meeting from the user who does not participate in the meeting. In the display screen of FIG. 4, the user who participates in the meeting is expressed by hatching added to a background. More preferably display 71 distinguishes the user who logs in terminal device 300 from other users. In the display screen of FIG. 4, the user who logs in terminal device 300 is expressed by hatching added to the background (in which an orientation of the hatching is opposite to that of the hatching added to the background of user who participates in the meeting). Accordingly, the display screen of FIG. 4 expresses that users A, C, E, F, and I participate in the currently holding meeting and that user I logs in terminal device 300. The display screen of FIG. 4 expresses an example in which a participation state of the meeting and the login user (user I) of terminal device 300 are displayed by existence or non-existence of the hatching and the orientation of the hatching. The participation state of the meeting and the login user of terminal device 300 may be displayed so as to be able to be distinguished by another method such as a background color and a frame border color. The login user of terminal device 300 may be displayed in a display area (not illustrated) different from display 71.

(Pointer Display)

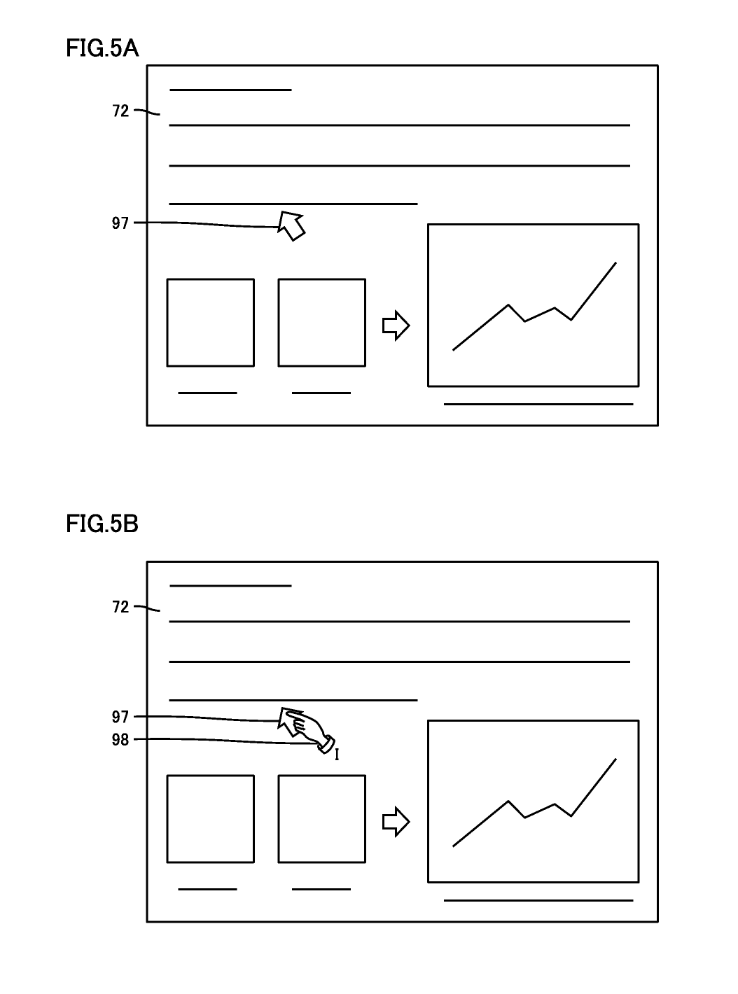

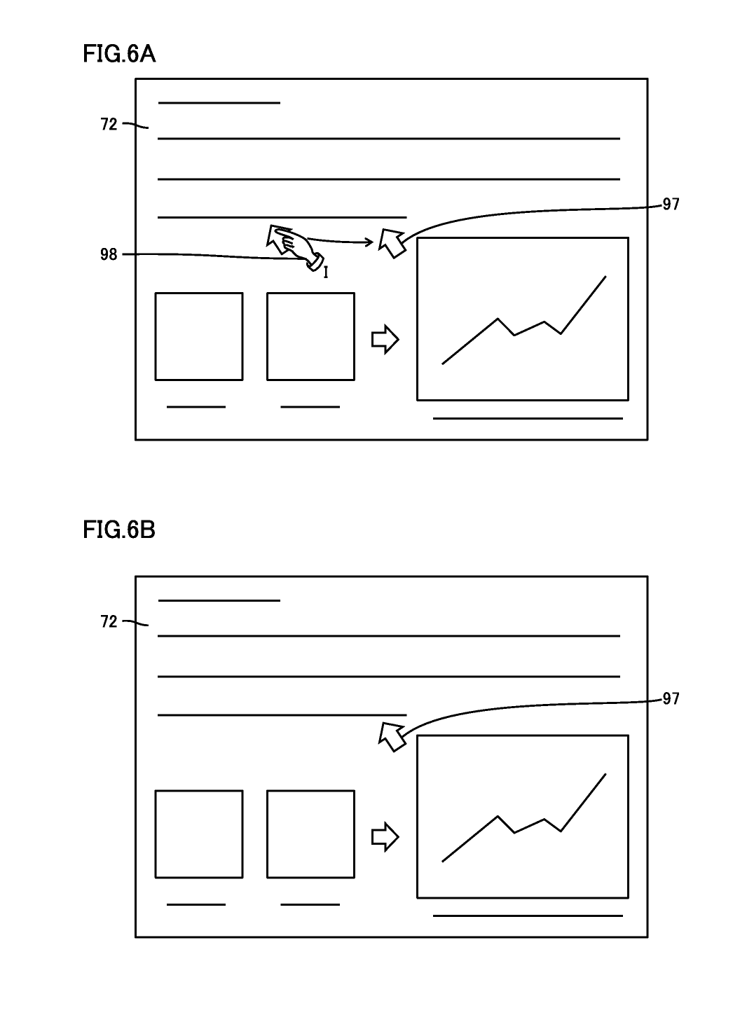

FIG. 5A to FIG. 6B are views illustrating a function of button 79. For the sake of convenience, FIG. 5A to FIG. 6B illustrate an area where the meeting material is displayed in the display screen of terminal device 300 in which user I logs. The user can cause other terminal devices 300 to display a pointer image in accordance with the instruction position by manipulating (clicking or touching) button 79. The pointer image is displayed in a mode corresponding to the user who issues the instruction.

FIG. 5A illustrates usual content display 72 before button 79 is manipulated. A pointer image 97 is usually displayed on usual content display 72 and at a position corresponding to the position of the manipulation instruction received by instruction device 34 of terminal device 300. Pointer image 97 moves in usual content display 72 in accordance with the user's instruction manipulation to instruction device 34. Usually terminal device 300 does not notify server 100 of the position of pointer image 97.

When the user manipulates button 79 while pointer image 97 is displayed as illustrated in FIG. 5A, the display in FIG. 5A is changed to the display in FIG. 5B. Specifically, when user manipulates button 79 in the state of FIG. 5A, a pointer image 98 in which user I who logs in terminal device 300 is distinguished from other users is displayed in addition to pointer image 97.

The display screen in FIG. 5B includes the pointer image displayed near the name of user I as an example of pointer image 98 in which user I is distinguished. Pointer image 98 may be a pointer image expressed by the color, shape, and motion that are previously defined in each user.

Pointer image 98 is displayed at the position expressed in pointer image 97 and the position in accordance with the user's instruction manipulation to instruction device 34. At this point, in accordance with the user's instruction manipulation to instruction device 34, pointer image 97 and pointer image 98 move in usual content display 72 while overlapping with each other (or being close to each other).

Terminal device 300 continuously notifies server 100 of the instruction of the position of pointer image 98 after the one-time manipulation of button 79, namely, the position in usual content display 72 received by instruction device 34 after the one-time manipulation of button 79. Server 100 distributes pointer image 98 to other terminal devices 300 while superimposing (writing) pointer image 98 in which user I is distinguished on the position of the currently playing-back content. Therefore, other users who participate in the meeting can see pointer image 98 in which user I is distinguished in usual content display 72. Additionally, other users can see pointer image 98 that moves in usual content display 72 in accordance with the manipulation of user I in substantially real time.

When the user manipulates button 79 in the state of FIG. 5B in which pointer image 98 is also displayed, namely, when the user manipulates button 79 for the second time, the display in FIG. 5B is changed to the display in FIG. 6A. Specifically, when the user manipulates button 79 for the second time, the display of pointer image 98 is fixed to the position where button 79 is manipulated for the second time. At this point, pointer image 97 still moves in usual content display 72 in accordance with the user's instruction manipulation to instruction device 34. Therefore, in the display screen of terminal device 300 of user I, depending on the user's instruction manipulation, pointer image 97 and pointer image 98 separate from each other as illustrated in FIG. 6A.

The notification made from terminal device 300 to server 100 by the one-time manipulation of button 79, the notification of the instruction of the position in usual content display 72 received by instruction device 34 is ended when button 79 is manipulated for the second time. Server 100 superimposes pointer image 98 on the position where the notification is finally made in the currently playing-back content, namely, the position closest to button 79 is manipulated for the second time, and distributes pointer image 98 to other terminals 300. Therefore, in terminal devices 300 of other users who participate in the meeting, pointer image 98 is displayed while the display position of pointer image 98 is fixed as illustrated in FIG. 6A. Pointer image 97 is not displayed in other terminal devices 300.

When the user manipulates button 79 in the state of FIG. 6A in which the display position of pointer image 98 is fixed, namely, when the user manipulates button 79 for the third time, the display in FIG. 6A is returned to the display in FIG. 6B, that is, the original state. Specifically, when the user manipulates button 79 for the third time, pointer image 98 is not displayed. Pointer image 97 may be displayed at the position of which terminal device 300 notifies server 100, the position corresponding to the position in usual content display 72 received by instruction device 34.

Even if a plurality of pointer images 98 are displayed in each terminal device 300, the user can learn which user issues the instruction of the pointer image at a glance by performing the above pointer display.

In the example of FIG. 5A to FIG. 6B, the pointer image is displayed or not displayed in a stepwise manner depending on the number of manipulation times of button 79. The display may be performed by the manipulation of another button except button 79. For example, another button is a button of the mouse.

(Handwritten Image and Marker Function)

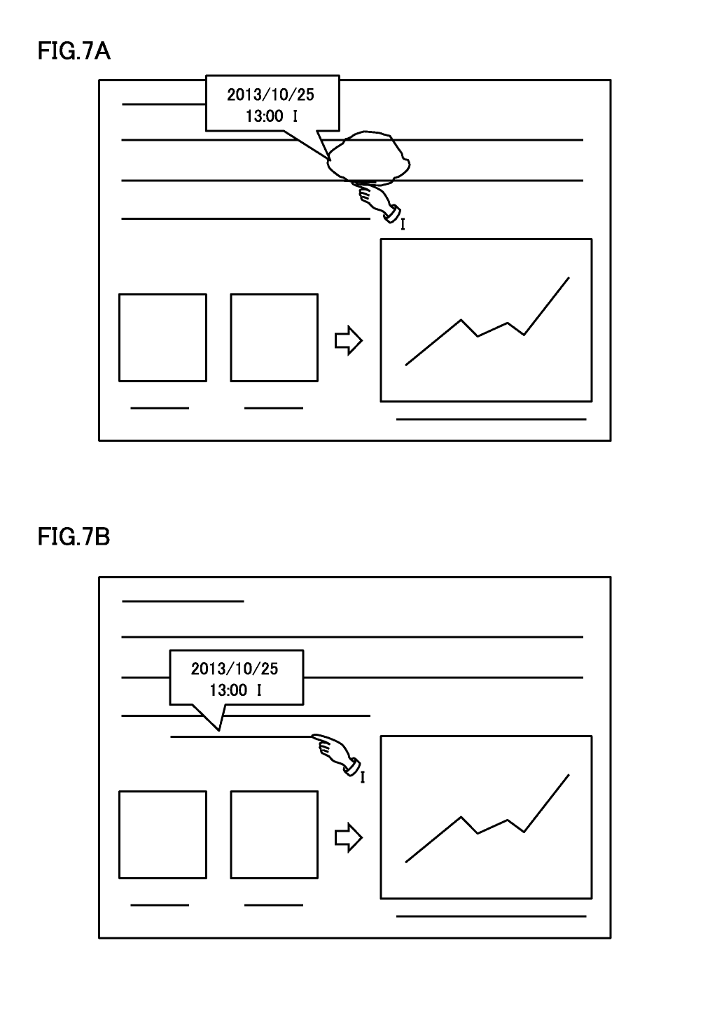

FIG. 7A is a view illustrating a function of button 78. FIG. 7B is a view illustrating a function of button 77. The user can add the handwritten image or the marker to the instructed position in the content by manipulating (clicking or touching) buttons 77 and 78. The user can display the added handwritten image or marker on other terminal devices.

The user manipulates button 78 on usual content display 72, and then moves the position of pointer image 97 using instruction device 34 of terminal device 300. Therefore, as illustrated in FIG. 7A, the handwritten image is input to usual content display 72 in accordance with the position of the user's instruction.

Terminal device 300 continuously notifies server 100 of the instruction of the position in usual content display 72, which is received by instruction device 34 after the manipulation of button 78. Server 100 identifies the input image based on the position, and distributes the input image to other terminal devices 300 while superimposing (writing) the input image on the currently playing-back content. Therefore, other users who participate in the meeting can see the handwritten image input by the user (user I) of terminal device 300.

When receiving the input of the handwritten image from terminal device 300, server 100 registers the handwritten image in the memory as the meeting history while correlating the hand written image with an input time and the user (user I) who manipulates the input of the handwritten image. Server 100 may receive information identifying the time the handwritten image is input from terminal device 300.

Preferably, when button 78 is manipulated in usual content display 72, pointer image 97 is switched to pointer image 98 as illustrated in FIG. 7A. In pointer image 98, user I who logs in terminal device 300 is distinguished. This display enables other users who participate in the meeting to learn which user inputs the handwritten image at a glance.

More preferably, the user performs a previously-defined manipulation to the handwritten image that is displayed while overlapping the handwritten image with the content, whereby the information on the time the handwritten image is input or the information identifying the user who performs the input manipulation is displayed as illustrated in FIG. 7A. For example, the previously-defined manipulation is a manipulation to overlap cursors with each other. Therefore, other users who participate in the meeting can easily learn which user and when the user inputs the handwritten image, even after the input time, namely, even after pointer image 98 is deleted.

The user manipulates button 77 in usual content display 72. Then, the user moves the position of pointer image 97 using instruction device 34 of terminal device 300. Therefore, as illustrated in FIG. 7B, the marker is added to usual content display 72 in accordance with the position of the user's instruction.

Terminal device 300 continuously notifies server 100 of the instruction of the position in usual content display 72, which is received by instruction device 34 after the manipulation of button 77. Server 100 identifies a starting position and an ending position of the marker based on the position of which terminal device 300 notifies server 100. Server 100 distributes the marker to other terminal devices 300 while superimposing the marker on the currently playing-back content. Therefore, other users who participate in the meeting can see the marker added by the user (user I) of terminal device 300.

When receiving the addition of the marker from terminal device 300, server 100 registers the marker in the memory as the meeting history while correlating the marker with the addition time and the user (user I) who manipulates the input of the marker. Server 100 may receive the information identifying the time the marker is input from terminal device 300.

Preferably, when button 77 is manipulated in usual content display 72, pointer image 97 is switched to pointer image 98 as illustrated in FIG. 7B. This display enables other users who participate in the meeting to learn which user adds the marker at a glance.

More preferably, the user performs a previously-defined manipulation to the marker added to the display of the content, whereby the information on the time the marker is added or the information identifying the user who performs the addition manipulation is displayed as illustrated in FIG. 7B. For example, the previously-defined manipulation is the manipulation to overlap cursors with each other. Therefore, other users who participate in the meeting can easily learn which user and when the user adds the marker, even after the time the marker is added, namely, even after pointer image 98 is deleted.

Preferably button group 81 is displayed at the time button 77 or button 78 is manipulated. The user manipulates one of the buttons in button group 81 expressing colors after manipulating button 77 or button 78. Therefore, the marker or handwritten image of the color corresponding to the color of the manipulated button is displayed. Terminal device 300 notifies server 100 of the selected color in addition to the instruction of the marker position or handwritten image position.

In the example of FIG. 7A and FIG. 7B, the handwritten image or the marker is superimposed on the content playback result on the side of server 100. The superimposed content playback result is distributed from server 100 to each terminal device 300. Alternatively, server 100 may transmit a content manipulated by user I who is the login user, the content being received from terminal device 300, to other terminal devices 300. That is, processing of superimposing the handwritten image or the marker may be performed on the side of each of other terminal devices 300.

(Synchronous Function)

The user manipulates button 84 to be able to select the synchronous and asynchronous outputs of the content playback result from terminal device 300 with the outputs of other terminal devices 300. Specifically, the user manipulates button 84 when the output of the content in terminal device 300 is synchronous with the outputs of other terminal devices 300. Therefore, the output in terminal device 300 becomes asynchronous with the outputs of other terminal devices 300. The user manipulates button 84 when the output of the content in terminal device 300 is asynchronous with the outputs of other terminal devices 300. Therefore, the output in terminal device 300 becomes synchronous with the outputs of other terminal devices 300.

When receiving the synchronous/asynchronous instruction, terminal device 300 notifies server 100 of the synchronous/asynchronous instruction. Based on the notification, server 100 determines whether content playback result is output. Alternatively, server 100 synchronously outputs the content playback result to each terminal device 300. Terminal device 300 may determine whether the content playback result from server 100 in accordance with the synchronous/asynchronous instructions.

The user manipulates button 84 to be able to select whether writing or the pointer is displayed in synchronization with other terminal devices 300. Specifically, the user manipulates button 84 when the output of the content in terminal device 300 is synchronous with the outputs of other terminal devices 300. Therefore, the output of the content in terminal device 300 becomes asynchronous with the outputs of other terminal devices 300. The user can cause the writing and pointer display of the user not to be displayed on other terminal devices 300 by this manipulation. The user can cause the writing and pointer display of each of other users not to be displayed on terminal device 300 of the user by this manipulation.

When the asynchronous instruction is selected, terminal device 300 does not notify server 100 of the instruction of the writing or pointer display, which is received by instruction device 34. Therefore, the writing and pointer display of the user of terminal device 300 are not displayed on other terminal devices 300. When being notified by terminal device 300 that the asynchronous instruction is selected, server 100 needs not distribute the writing and pointer display of terminal device 300 to other terminal devices 300. Server 100 needs not register, in the memory, pieces of input information such as the writing and pointer display of terminal device 300 in which the asynchronous instruction is selected, or server 100 may register the pieces of input information in the memory after determining whether the pieces of input information are input in the asynchronous or synchronous state.

(Outline of Operation During Meeting)

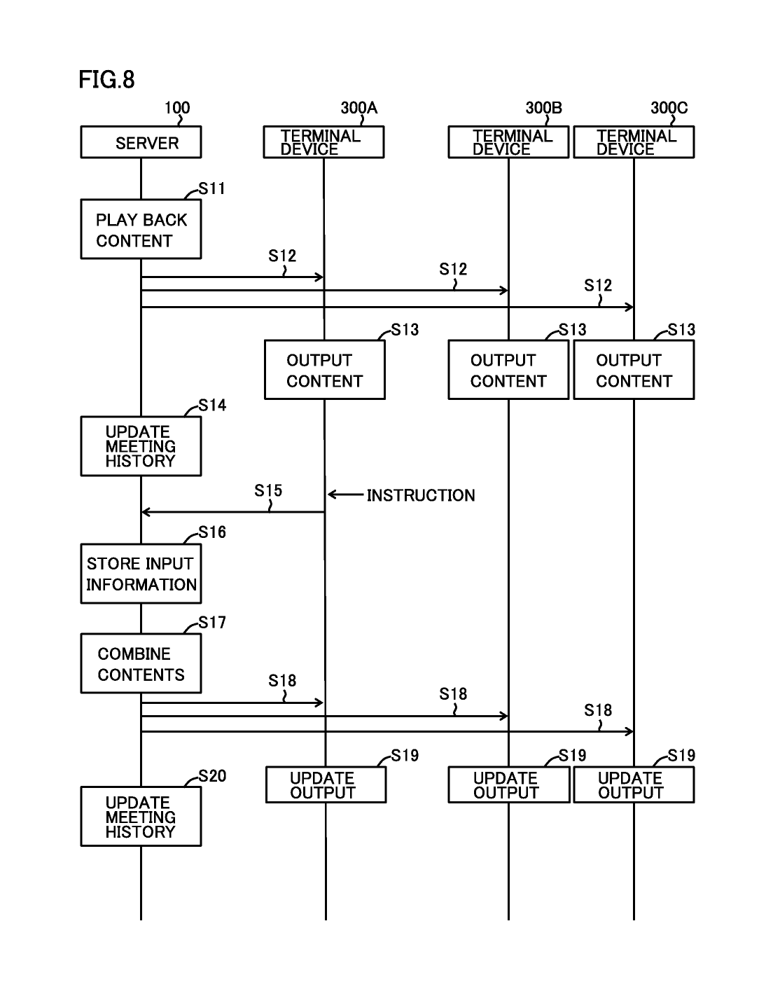

FIG. 8 is a view illustrating an example of an operation outline of the system during the meeting. Referring to FIG. 8, during the meeting, server 100 plays back the assigned content in accordance with the previously-registered time or the instruction of terminal device 300 (step S11). Server 100 synchronously distributes the content playback result to terminal devices 300 of the plurality of users who log in the system in order to participate in the meeting (step S12). Alternatively, server 100 synchronously distributes the content playback result only to terminal device 300 in which the synchronous instruction is selected. Terminal device 300 receives the content playback result from server 100, and outputs the content playback result (step S13).

Server 100 registers a participation situation of the user who participates in the meeting in the memory as the meeting history. For example, the participation situation is the existence or non-existence of the login of the user. Preferably the participation situation is a login period of each user. More preferably the participation situation is a synchronous/asynchronous period of each user. When playing back the content in the meeting, server 100 records a playback period of the content in the meeting history. Therefore, the meeting history is updated (step S14).

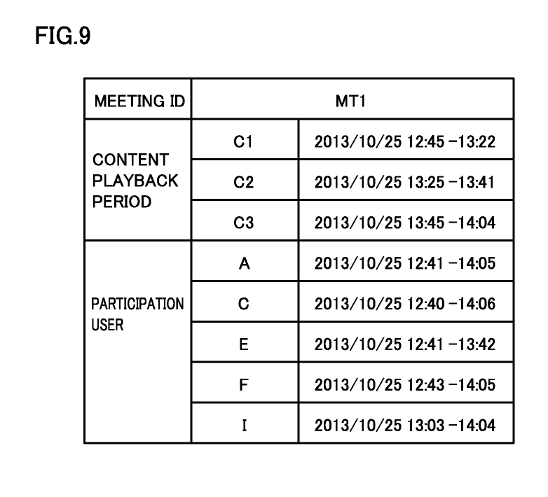

FIG. 9 is a view illustrating an example of the meeting history. Referring to FIG. 9, the meeting history includes identification information, a playback situation of the played-back content, and the participation user, on each meeting. The meeting history is registered in the memory of server 100. For example, the playback situation of the played-back content is the playback period. Preferably the information on the participation user of the meeting, which is included in the meeting history, includes the participation situation as illustrated in FIG. 9. For example, the participation situation is the login period. Which terminal device 300 outputs the content playback result, namely, which user plays back the content can be seen by referring to the meeting history. Preferably the information on the participation user of the meeting, which is included in the meeting history, includes the synchronous/asynchronous period of the user. Which user actually plays back the content can be seen by referring to the meeting history.

Terminal device 300 notifies server 100 of the instruction content of the handwriting, marker, or pointer display, which is received from the user (step S15). When receiving the notification from terminal device 300, server 100 fixes the input content. Server 100 stores the input information in the memory as the meeting information (step S16).

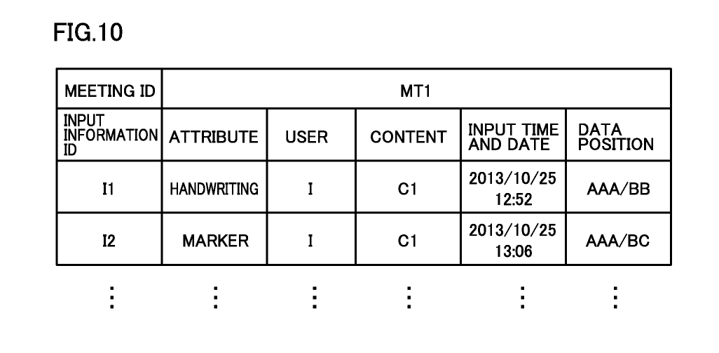

FIG. 10 is a view illustrating an example of the input information stored in the memory as the meeting information. Referring to FIG. 10, the meeting information includes meeting identification information, information (input information ID) identifying the input information, an attribute such as the handwriting and marker, the user who performs the manipulation, the input target content, the time the manipulation is performed, and the position on the memory in which the handwritten or marker image that is of a main body of the input information is stored.

In each meeting, server 100 registers the meeting information of FIG. 10 in the memory. That is, in each meeting, server 100 registers the information handwritten during the meeting by each user who participates in the meeting and the information to which the marker is added by the user. Therefore, the input information can be confirmed by referring to the meeting information even after the meeting.

Based on the notification from terminal device 300, server 100 combines the handwriting or the marker, which is received from the user, with the content (step S17). Server 100 distributes the post-combination content playback result to terminal device 300 (step S18).

Terminal device 300 outputs the distributed content playback result. Therefore, the output of terminal device 300 is updated (step S19).

Using terminal device 300, the user performs the manipulation to input the handwritten image or the manipulation to add the marker. Based on the notification from terminal device 300, server 100 identifies the handwritten image or the marker image. Server 100 combines the identified image with the content.

Using terminal device 300, the user performs the manipulation to display the pointer. Based on the notification from terminal device 300, server 100 identifies the position of pointer image 98 and the user who performs the manipulation. Server 100 combines the identified pointer image 98 with the content.

Server 100 records the content playback situation of the meeting history in accordance with the playback of the content. Therefore, the meeting history is updated (step S20).

The system performs the operation in FIG. 8 during the meeting. Through the operation, the content and the image (such as the handwritten image and the marker) in accordance with the manipulation of the user who participates in the meeting are synchronously displayed in each terminal device 300. Through the operation, the content playback situation and the participation user are registered in the memory of server 100 as the meeting history. The information, such as the handwritten image, which is input to the content, is registered in the memory of server 100 as the meeting information through the operation.

(Registration of Meeting)

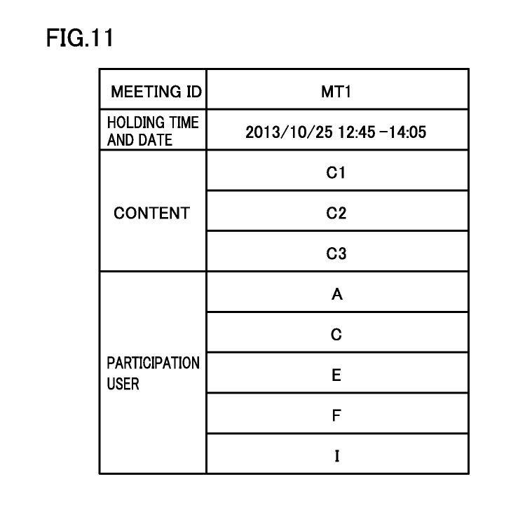

The meeting information may previously be registered in server 100 in order that the system performs the above operation. FIG. 11 is a view illustrating an example of the previously-registered meeting information. Referring to FIG. 11, the previously-registered meeting information includes the meeting identification information (meeting ID), a holding period, the played-back content, and the participation user of each meeting to be held. The previously-registered meeting information may also include the playback period of each content.

The user who wants to hold the meeting can easily start the meeting with terminal device 300 by previously registering the meeting information in FIG. 11. For example, the user who wants to hold the meeting selects the corresponding meeting information. Therefore, the screen in FIG. 4 is displayed on terminal device 300. The user selects the playback target content from meeting material display 74 of the screen in FIG. 4. Therefore, the meeting is started.

Alternatively, server 100 makes a notification of the holding of the meeting when a holding period (or a period before the meeting is held) included in the previously-registered meeting information comes. For example, the notification of the holding of the meeting is an electronic mail transmitted to the participation user. Server 100 transmits the information displayed on the screen in FIG. 4 to each terminal device 300.

Alternatively, server 100 automatically starts the content playback in accordance with the content playback period registered in the meeting information. Server 100 distributes the content playback result to terminal device 300 correlated with each the registered participation users. When distributing the content playback result, server 100 may refer to the meeting information to authenticate the user based on the login information from each terminal device 300.

(History Display)

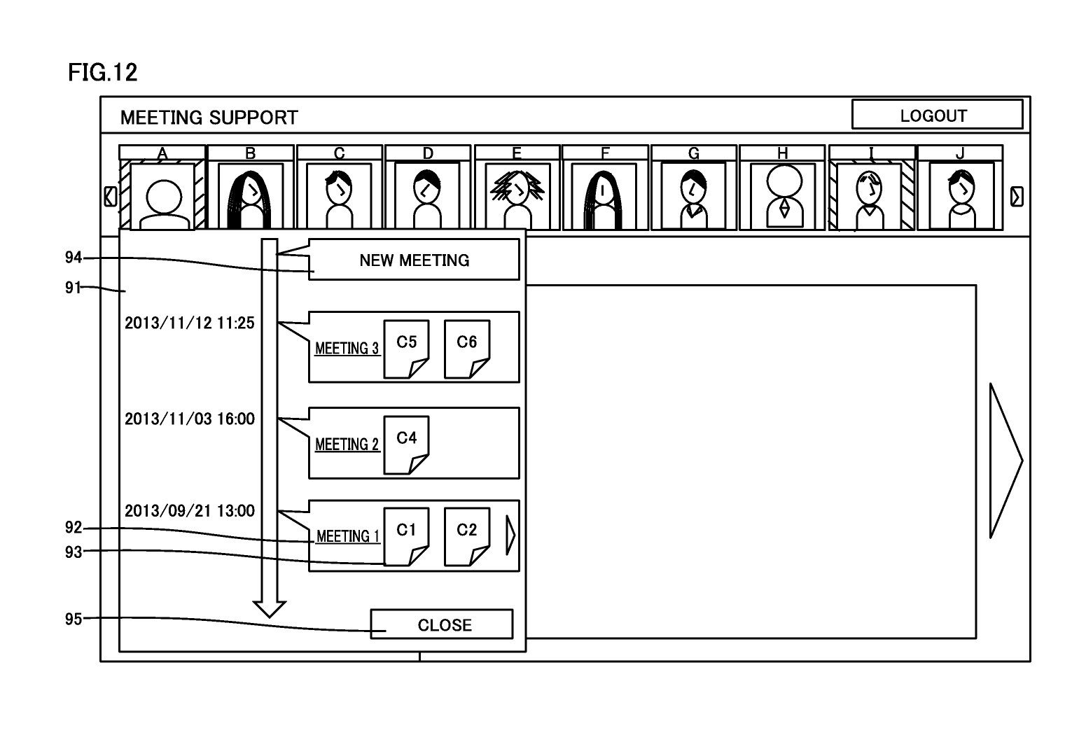

FIG. 12 is a view illustrating a display example of a user participation history on the meeting support screen. The user assigns the user by manipulating (clicking or touching) one of icons of the users included in display 71 on the meeting support screen in FIG. 4. Therefore, the meeting participation history of the assigned user is displayed as illustrated in FIG. 12. Only the information on the meeting in which browsing authority is provided to the manipulating user (login user) may be displayed in the meeting participation history of the assigned user.

Referring to FIG. 12, a participation history display 91 includes a display 92 and buttons 94 and 95. Display 92 expresses the meeting that the assigned user participates in. Button 95 is used to close display 91. Button 94 is used to issue an instruction to register a new meeting.

In the example of FIG. 12, participation history display 91 is located on the meeting support screen in FIG. 4, and arranged near the icon of the assigned user (user A) included in display 71 while overlapping with display 71. Therefore, the user can easily understand the participation history of the assigned user. Alternatively, the screen on which the participation history of the assigned user is displayed may be switched from the meeting support screen in FIG. 4.

In the example of FIG. 12, displays 92 are arranged along a line expressing an elapsed time. The line expressing the elapsed time is also called a time line. Preferably, display 92 is displayed together with holding time and date. In other words, displays 92 are arranged in order based on the holding time and date, namely, in time series. Therefore, the user can confirm the meetings that the assigned user participates in the holding order.

Server 100 receives notification that the user is assigned from terminal device 300. Server 100 refers to the meeting history registered in the memory to identify the meeting in which the assigned user is recorded as the participation user. Server 100 transmits the information on the identified meeting to terminal device 300. The information on the meeting is information, such as the meeting ID, which expresses the meeting.

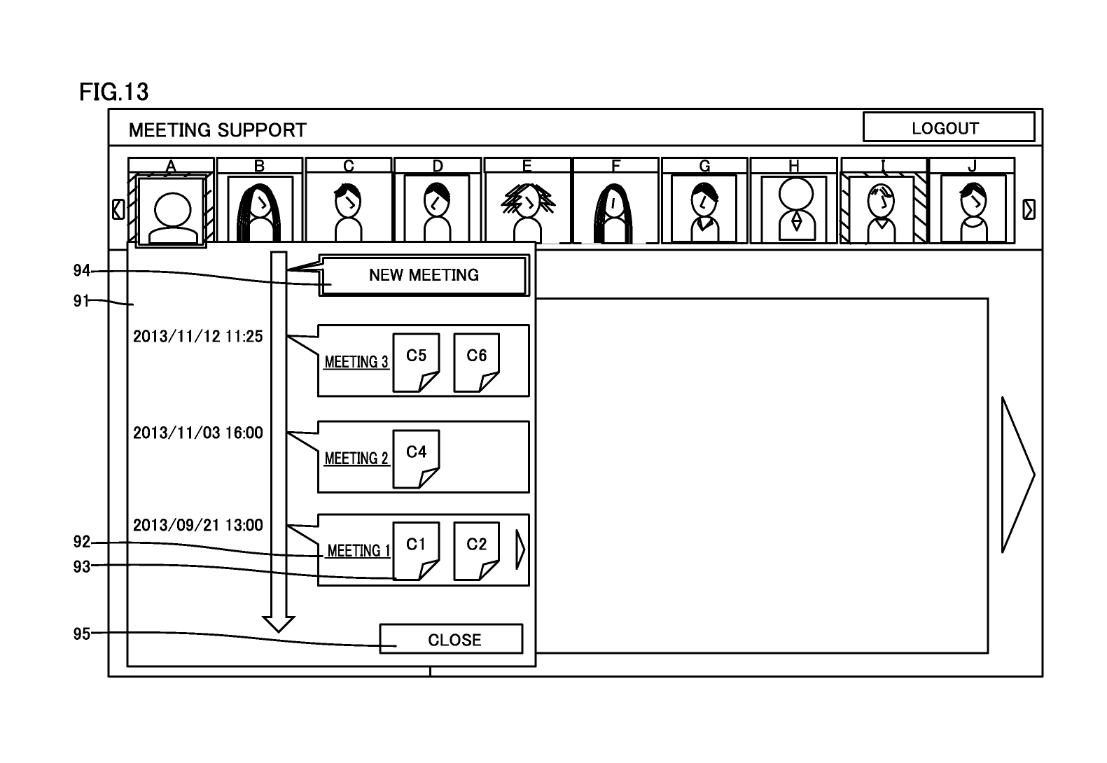

Preferably, as illustrated in FIG. 12, display 92 includes display 93 for the content played back in the meeting. When the user manipulates (clicks or touches) display 93 in FIG. 12, the display screen in FIG. 12 is changed to the display screen in FIG. 13. The user manipulates (clicks or touches) content display 93 in FIG. 12 to select the content, which allows the presentation of the user who plays back the selected content. The display screen in FIG. 13 is displayed when content C1 is selected. The display screen in FIG. 13 is displayed in a mode different from other users such that users A, C, E, and F who play back content C1 are highlighted.

Server 100 receives the notification that the content is selected from terminal device 300. Server 100 refers to the meeting history registered in the memory to identify the user who participates in the meeting in which the selected content is played back, namely, the user who logs in the meeting. Preferably, the server 100 identifies the login user in the playback period of the selected content. More preferably, the server 100 identifies the user who selects the synchronization of the distribution of the playback result in the playback period of the selected content. Server 100 transmits the information on the identified user to terminal device 300. The information on the user is information, such as a user name, which expresses the user.

In the example of FIG. 13, when content C1 is selected, server 100 refers to the meeting history in FIG. 9 that includes content C1 as the played-back content (meeting material). Server 100 identifies the playback period of content C1. Server 100 further refers to the meeting history in FIG. 9 to identify log in users A, C, E, and F in the playback period in the participation users. Server 100 transmits the information about these users to terminal device 300. When receiving the information, terminal device 300 displays users A, C, E, and F in the highlighted manner as illustrated in FIG. 13.

By performing the display in FIG. 13, the user can easily learn the user who plays back the selected content, for example, the user who browses the document file that is of the meeting material. For example, in the case that the user wants to ask a question about the selected content, the user can easily learn which user effectively answers the question.

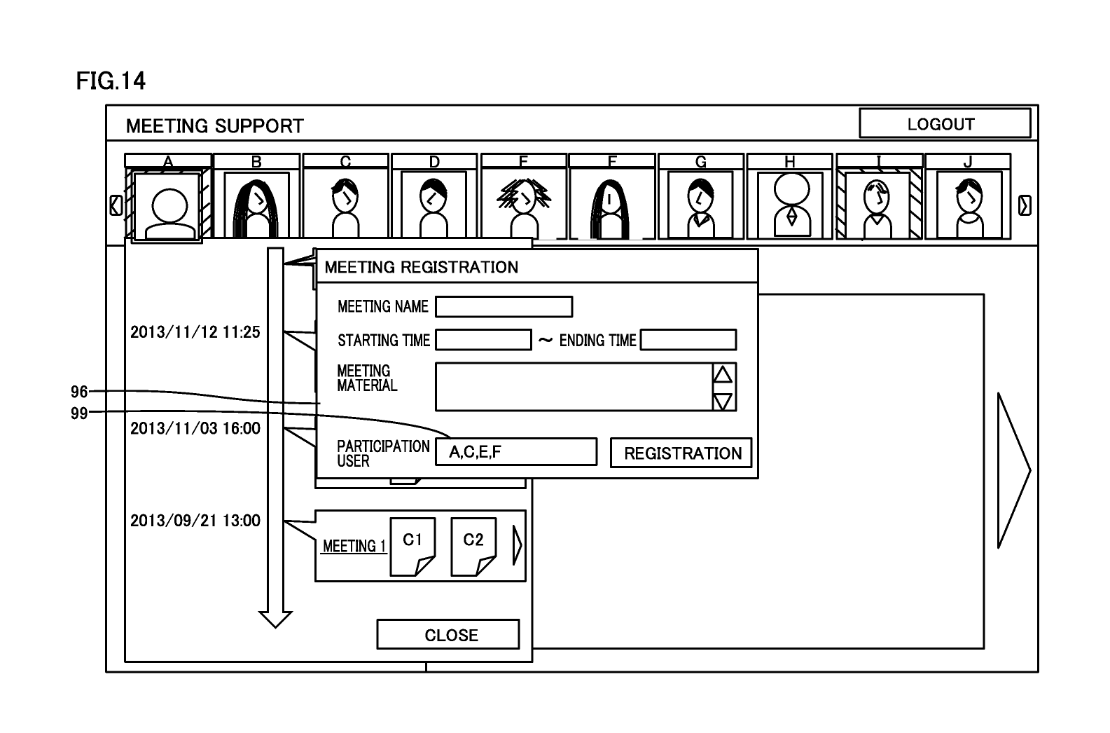

When the user manipulates (clicks or touches) button 94 in FIG. 13, the display in FIG. 13 is changed to the display in FIG. 14. FIG. 14 illustrates an example in which a screen 96 is displayed while overlapping with the display screen in FIG. 13. Screen 96 is used to register the meeting information on the new meeting.

The user can register the meeting information on the new meeting using screen 96 in FIG. 14. Referring to FIG. 14, screen 96 includes a field to which a meeting name is input, a field to which the holding period of the meeting is input, and a field to which the content (meeting material) to be played back in the meeting is input. Screen 96 also includes a field 99 to which the meeting participant is input. Screen 96 is displayed in the state in which the users who play back the selected content, the users being presented on the screen in FIG. 13, are previously input to field 99. That is, the user can register the new meeting in which the presented users are participants by manipulating button 94 on the screen in FIG. 13 in which the user who plays back the selected content.

Terminal device 300 transmits the information received in screen 96 to server 100. Server 100 registers the information transmitted from terminal device 300 in the memory as the previously-registered meeting information. Server 100 registers the previously-registered meeting information in the memory by two methods, namely, a method of displaying a registration screen (not illustrated) on terminal device 300 to receive the input of a necessary item and a method of receiving the input of the necessary item on screen 96.

When the new meeting is registered in the memory of server 100 in the above manner, the user can easily register the new meeting aimed at the users who play back (browse) specific files such as the document file.

Server 100 may distribute the information used to display the screen in FIG. 12, the screen in FIG. 13, or the screen in FIG. 14 to terminal device 300 during the playback of the content. Terminal device 300 displays the screen in FIG. 12, 13, or 14 while the screen overlaps with the currently-output content playback result.

Alternatively, terminal device 300 switches the display screen of the content playback result to the screen in FIG. 12, 13, or 14. The display of the screen in FIG. 12, 13, or 14 enables the user to register the new meeting during the meeting.

(Outline of Operation During Presentation and New Registration)

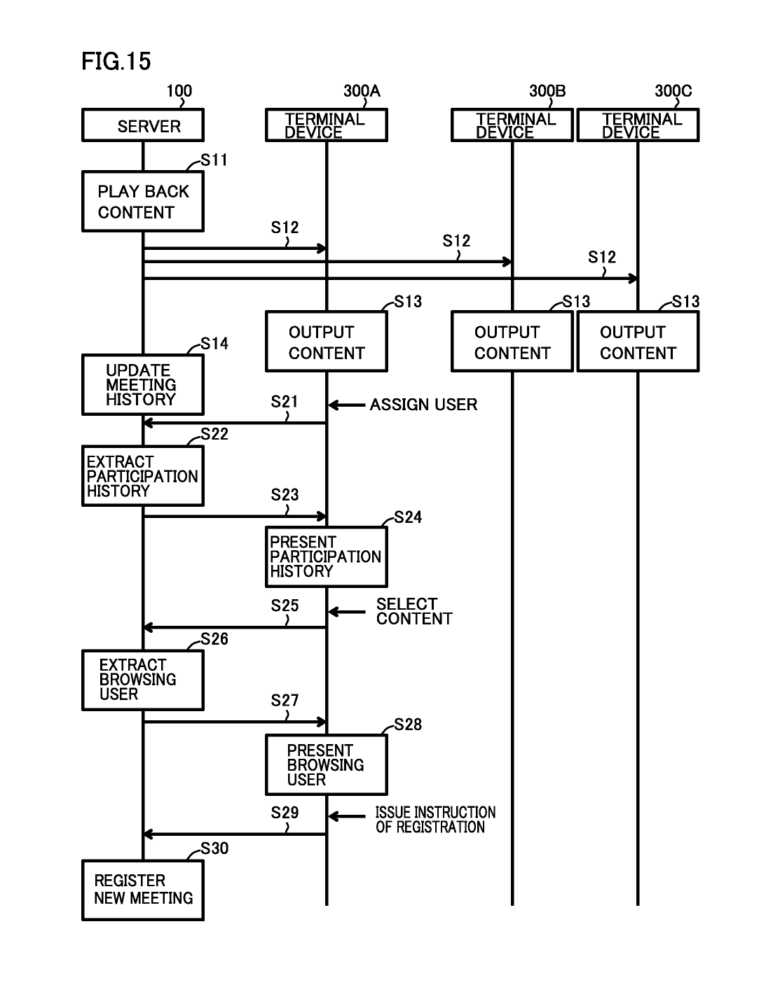

FIG. 15 is a view illustrating an outline of the operation of the system during a presentation and a new registration. Referring to FIG. 15, because the operations in steps S11 to S14 are identical to those in FIG. 8, the overlapping description is not repeated. Terminal device 300 receives the user's manipulation to assign the user in display 71 on the screen in FIG. 4. Therefore, terminal device 300 notifies server 100 of the manipulation content (step S21).

Server 100 refers to the meeting history stored in the memory to extract the meeting history that the assigned user participates in (step S22). Server 100 transmits the information indicating the extracted meeting to terminal device 300 (step S23). Terminal device 300 that receives the information presents the participation history of the assigned user (step S24). Participation history display 91 in FIG. 12 is displayed in terminal device 300.

Terminal device 300 receives the selection of the content in participation history display 91. Terminal device 300 notifies server 100 of the selected content (step S25).

Server 100 refers to the meeting history stored in the memory to extract the user who plays back (browses) the selected content (step S26). Server 100 transmits the information about the extracted user to terminal device 300 (step S27). Terminal device 300 that receives the information presents the user who plays back the selected content (step S28). As illustrated in FIG. 13, the corresponding user is displayed in the highlighted manner in terminal device 300.

In the display state of FIG. 13, terminal device 300 receives the manipulation to register the new meeting from the user. Terminal device 300 notifies server 100 of the manipulation content (step S29). Server 100 registers, in the memory, the previously-registered meeting information on the new meeting in which the users extracted in step S26 are the participation user (step S30).

<Functional Configuration>

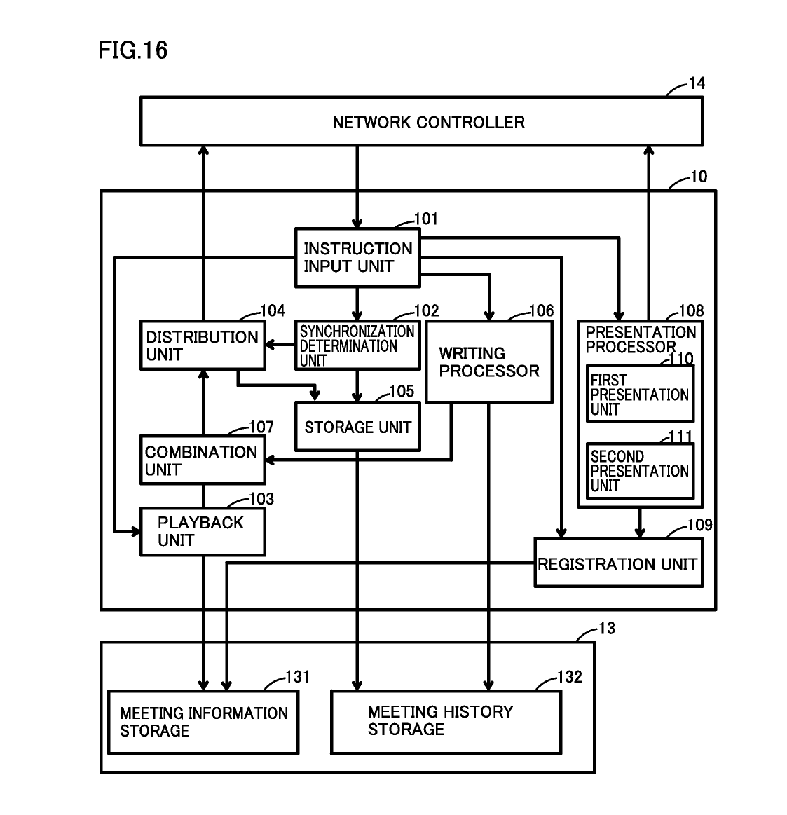

FIG. 16 is a block diagram illustrating a specific example of a functional configuration of server 100 in order to perform the above operation. CPU 10 of server 100 reads the program stored in ROM 11 onto RAM 12 and executes the program to implement each function in FIG. 16. Alternatively, at least a function may be implemented by another piece of hardware in FIG. 2 or hardware such as an electric circuit (not illustrated).

Referring to FIG. 16, HDD 13 includes a meeting information storage 131 that is of a storage area in which the meeting information is stored and a meeting history storage 132 that is of a storage area in which the meeting history is stored.

Referring to FIG. 16, CPU 10 includes an instruction input unit 101, a synchronization determination unit 102, a playback unit 103 that plays back the content, a distribution unit 104 that distributes the content playback result, and a storage unit 105 that stores the meeting history in the memory. Instruction input unit 101 receives the input such as the instruction notification from terminal device 300 through network controller 14. Synchronization determination unit 102 determines whether the synchronous/asynchronous instruction is selected in terminal device 300.

CPU 10 includes a writing processor 106, a combination unit 107, a presentation processor 108, and a registration unit 109. Presentation processor 108 presents the participation history of the assigned user or the user who browses the selected content in terminal device 300. Registration unit 109 registers the meeting information on the new meeting.

Writing processor 106 identifies the input image based on the notification from terminal device 300, and identifies the position of the pointer image and the input user. Writing processor 106 transfers the identified information to combination unit 107. Combination unit 107 combines the image (the input image and the pointer image) with the played-back content based on the identified information.

Playback unit 103 plays back the assigned content in accordance with the user's instruction input from terminal device 300 or the meeting information registered in the memory. Distribution unit 104 distributes the content playback result or the combination result of combination unit 107 to terminal device 300 in which the synchronous instruction is determined to be selected.

Storage unit 105 records the user who logs in the system during the meeting holding period in the meeting history as the user who participates in the meeting. Preferably storage unit 105 records the playback period of each content and the login period of each user in the meeting history.

Presentation processor 108 includes a first presentation unit 110 and a second presentation unit 111. First presentation unit 110 refers to the meeting history to present the meeting that the user participates in and the content played back in the meeting on terminal device 300 as the participation history of the assigned user. Second presentation unit 111 refers to the meeting history to present the user who plays back the selected content in the contents presented by first presentation unit 110 on terminal device 300.

Registration unit 109 registers the meeting information to be previously-registered on the new meeting in the memory in accordance with the specific manipulation from terminal device 300. The new meeting is a meeting in which the user who plays back the selected content is the user who plans to participate in the meeting, the meeting being presented by second presentation unit 111.

<Operation Flow>

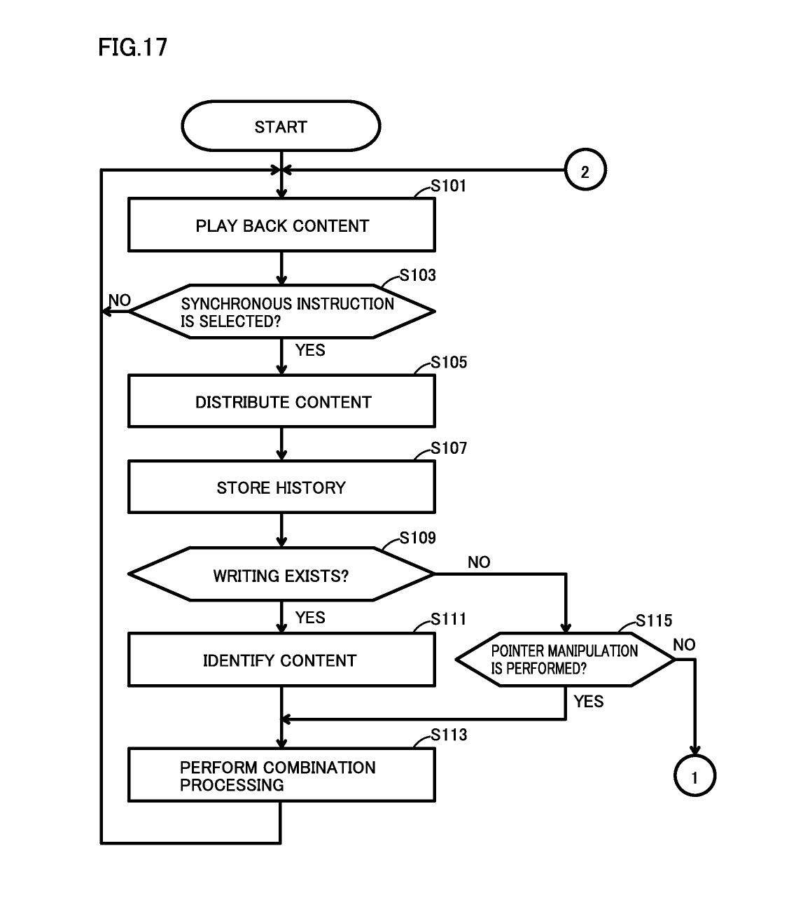

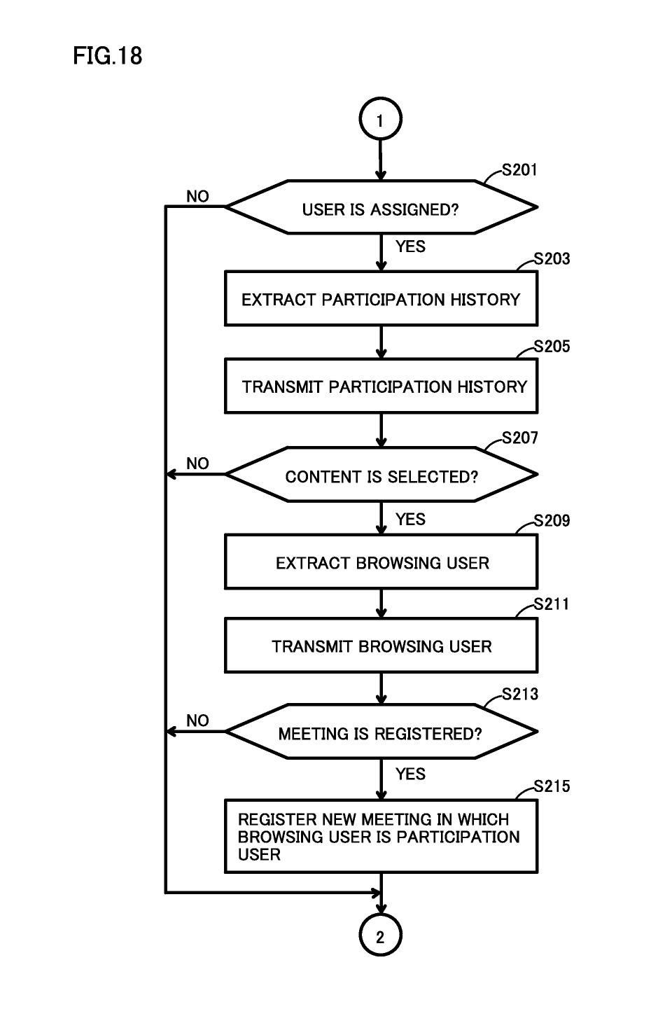

FIG. 17 and FIG. 18 are flowcharts illustrating an example of the operation of server 100. CPU 10 of server 100 reads the program stored in ROM 11 onto RAM 12, and executes the program to exert each function in FIG. 16, thereby implementing the operation of the flowcharts in FIG. 17 and FIG. 18. When the meeting is held, CPU 10 of server 100 starts the operation of the flowcharts in FIG. 17 and FIG. 18.

Referring to FIG. 17, CPU 10 of server 100 plays back the content that is set to be played back in the meeting (step S101). CPU 10 distributes the content playback result to terminal device 300 in which the synchronous instruction is selected (if YES in step S103, step S105). CPU 10 registers the playback of the content in the meeting history and stores the playback of the content in the memory. CPU 10 also registers the participation situation of the user in the meeting history. For example, the participation situation of the user is the existence or non-existence of the login, the login period, and the synchronous/asynchronous instruction. Therefore, the meeting history is updated (step S107).

When receiving the notification that the writing image is input or the notification that the marker is added from terminal device 300 (YES in step S109), CPU 10 identifies the content of the input image (step S111). CPU 10 combines the input image with the currently-played-back content (step S113). When receiving the instruction to display the pointer in which the user is identified from terminal device 300 (NO in step S109 and YES in step S115), CPU 10 combines the corresponding pointer image with the currently-played-back content together with the identification information on the user (step S113). CPU 10 returns the processing to the initial state and repeats the sequence of pieces of processing.

Referring to FIG. 18, when receiving the instruction to assign the user from terminal device 300 (YES in step S201), CPU 10 refers to the meeting history to extract the history of the meeting that the assigned user participates in (step S203). CPU 10 transmits the participation history of the assigned user to terminal device 300 (step S205).

When receiving the selection of the content in the participation history from terminal device 300 (YES in step S207), CPU 10 refers to the meeting history to extract the user who browses the selected content (step S209). CPU 10 transmits the information indicating the extracted user to terminal device 300 (step S211).

When receiving the instruction to register the new meeting from terminal device 300 (YES in step S213), CPU 10 registers the meeting information on the new meeting in which the user who browses the selected content is the user who plans to participate in the meeting, the user being extracted in step S209, in the memory (step S215). Alternatively, in step S215, CPU 10 may receive the inputs of other pieces information such as the meeting name and the holding period, and the instruction for registration from terminal device 300 as the meeting information, and register the meeting information.

After the above pieces of processing, CPU 10 returns the processing to the initial state and repeats the sequence of pieces of processing.

The operations in FIG. 17 and FIG. 18 are performed by CPU 10 during the meeting. That is, in the meeting holding period, the processing of presenting the participation history in accordance with the instruction from terminal device 300 or the processing of registering the new meeting is performed during the playback of the content. Alternatively, the processing of presenting the participation history in accordance with the instruction from terminal device 300 or the processing of registering the new meeting may be performed independently of the playback of the content. That is, CPU 10 may perform the processing of presenting the participation history in accordance with the instruction from terminal device 300 or the processing of registering the new meeting out of the meeting period.

### Effect of Embodiment

The system performs the above operations to synchronously display the contents, such as the document file, which are used in the meeting, in each terminal device 300. The image written in the content by each user, the marker added by each user, and the pointer image correlated with each user are also synchronously displayed in each terminal device 300 together with the contents. Therefore, the user of each terminal device 300 can participate in the meeting even if the user is in a remote place.

In the system, whether the output of the content is synchronous with other terminal devices 300 can be selected using each terminal device 300. Therefore, convenience of the user of each terminal device 300 can be improved.

The user of each terminal device 300 can see the history of the meeting that the assigned user participates in by the simple manipulation such as the manipulation to assign the user on the display screen. For example, when the user wants to learn the meeting material browsed by a certain user who participates in the meeting, the user can easily learn the meeting material using the system.

The user can select the content by the simple manipulation, and learn the user who outputs (browses) the selected content. For example, the simple manipulation is the manipulation to assign the user to select the content, which is used in the meeting and included in the history of the meeting that the assigned user participates in. For example, when the user wants to learn the user suitable to a question about the selected meeting material, the user can easily learn the user who previously browses the selected meeting material using the system.

By the simple manipulation, the user can register the meeting information on the new meeting in which a certain user is the user who plans to participate in the meeting. For example, the simple manipulation is the manipulation to press the new meeting button in the state where the user who browses the selected meeting material is presented. For example, when the meeting is held again by the users who previously see the selected meeting material, the users can easily register the new meeting using the system without assigning the participation user again.

That is, the system can support the meeting such that the meeting involving the playback of the content with a plurality of terminal devices 300 is smoothly held and progressed.

### Second Embodiment

In the first embodiment, server 100 performs the processing of playing back and distributing the content, the processing of presenting the participation history of the assigned user, the processing of presenting the user who browses the selected content, and the processing of registering the new meeting. Alternatively, terminal device 300 may perform at least one piece of processing. In such cases, CPU 30 of terminal device 300 reads the program stored in ROM 31 onto RAM 32 and executes the program, thereby implementing the corresponding function in the functions in FIG. 16. Accordingly, the functions in FIG. 16 may be implemented by either CPU 10 of server 100 or CPU 30 of terminal device 300.

### Third Embodiment

A program can be provided in order to cause CPU 10 of server 100 or CPU 30 of terminal device 300 to execute the operations. Therefore, a general computer or a general terminal device can cause to act as server 100 or terminal device 300. The system can be constructed with an existing device by providing the program.

The program can be provided as a program product in a state of being recorded in a computer-readable recording medium such as a flexible disk belonging to a computer, a CD-ROM (Compact Disk-Read Only Memory), a ROM, a RAM, and a memory card. Alternatively, the program can be provided in a state of being recorded in a recording medium such as a hard disk incorporated in the computer. The program can be provided by downloading the program through the network.

In the program of the present invention, a necessary module may be called and executed with a predetermined array at a predetermined time out of program modules provided as a part of an operating system (OS) of the computer. In this case, the program itself does not include the module, and the processing is performed in conjunction with the OS. The program that does not include the module can be included in the program of the present invention.

The program of the present invention may be provided by being incorporated in a part of another program. In this case, the program does not include the module included in another program, and the processing is performed in conjunction with another program. The program incorporated in another program can be included in the program of the present invention.

The provided program product is executed by being installed onto a program storage unit such as the hard disk. The program product includes the own program and the recording medium in which the program is recorded.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A meeting support method of supporting a meeting involving playback of a content using a server and a plurality of terminal devices connected to said server, the meeting support method comprising:
playing back the content correlated with the meeting and synchronously distributing a playback result to said plurality of terminal devices using said server;
storing an information identify a time the meeting is held, the content played back in the meeting, and an information identify a user who participates in said meeting, as a meeting history in each meeting;
referring to said meeting history to present information about the meeting that an assigned user participates in and the content played back in the meeting on the terminal device in which said user is assigned; and
referring to said meeting history to present information about a user who plays back a selected content in said presented contents on the terminal device with which said content is selected.

2. The meeting support method according to claim 1, wherein said storing includes storing an information identify a user who logs in at a time said meeting is held, in said meeting history as the user who participates in said meeting.

3. The meeting support method according to claim 2, wherein said storing includes storing an information identify a playback period of each content and an information identify a login period of said user in said meeting history.

4. The meeting support method according to claim 1, further comprising registering the content to be played back in the meeting and the user who plans to participate in the meeting as meeting information in each meeting, wherein
said distributing includes referring to said meeting information to play back said content using said server, and
said registering includes receiving a previously-defined manipulation to register the meeting information on a new meeting in which the user who plays back said selected content is the user who plans to participate in the meeting.

5. A server that supports a meeting involving playback of a content with a plurality of terminal devices, the server comprising:
a playback unit for playing back the content;
a communication unit for communicating with said plurality of terminal devices;
a controller; and
a memory, wherein
said controller is configured to:
cause said playback unit to play back the content correlated with the meeting, and
synchronously distribute a playback result of said playback unit to said plurality of terminal devices,
said memory is configured to store an information identify a time the meeting is held, the content played back in the meeting, and an information identify a user who participates in said meeting are stored, as a meeting history,
said controller is configured to:
transfer information about the meeting that an assigned user participates in and the content played back in the meeting in order to present the information on said terminal device in accordance with user assignment received from said terminal device, the information being registered in said meeting history, and
transfer information about the user who plays back a selected content in order to present the information on said terminal device in accordance with content selection in the content transferred in accordance with the user assignment received from said terminal device, the content selection being received from said terminal device, the information being registered in said meeting history.

6. The server according to claim 5, wherein the user who participates in said meeting registered in said meeting history includes an information identify a user who logs in at a time the meeting is held.

7. The server according to claim 6, wherein said meeting history includes an information identify a playback period of each content and an information identify a login period of the user who participates in said meeting.

8. The server according to claim 5, wherein
said memory is further configured to store the content to be played back in the meeting and an information identify the user who plans to participate in the meeting are stored, as meeting information in each meeting,
said controller is configured to:
refer to said meeting information to cause said playback unit to play back said content, and
register meeting information on a new meeting, in which the user who plays back said selected content is the user who plans to participate in the meeting, in said storage area in accordance with a previously-defined manipulation.

9. A terminal device that supports a meeting involving playback of a content, the terminal device comprising:
a communication unit for communicating with a server;
an instruction device;
a display unit; and
a controller,
wherein
said controller is configured to display a playback result of the content correlated with the meeting on said display unit, the playback result being received from said server,
a memory of said server is configured to store an information identify a time the meeting is held, the content played back in the meeting, and an information identify a user who participates in said meeting are stored, as a meeting history in each meeting,
said controller is configured to:
display information about the meeting that an assigned user participates in and the content played back in the meeting on said display unit in accordance with user assignment received from said terminal device, the information being registered in said meeting history, and
display information about the user who plays back a selected content on said display unit in accordance with content selection in the content transferred in accordance with the user assignment received from said terminal device, the content selection being received from said terminal device, the information being registered in said meeting history.

10. A meeting support system that supports a meeting involving playback of a content, the meeting support system comprising:
a module for playing back the content correlated with the meeting to synchronously distribute a playback result to a plurality of terminal devices using a server;
a module for storing an information identify a time the meeting is held, the content played back in the meeting, and an information identify a user who participates in said meeting, as a meeting history in each meeting;
a module for referring to said meeting history to present information about the meeting that an assigned user participates in and the content played back in the meeting on the terminal device with which said user is assigned; and
a module for referring to said meeting history to present information about a user who plays back a selected content in said presented contents on the terminal device with which said content is selected.
